(19) United States
(12) Patent Application Publication
(10) Pub. No.: US 2003/0103523 A1
(43) Pub. Date: Jun. 5, 2003

(54) System and method for equal perceptual relevance packetization of data for multimedia delivery

(75) Inventors: Pascal Frossard, Harrison, NY (US); Pierre Vandergheynst, Berolle (CH); Olivier Verscheure, Harrison, NY (US)

Correspondence Address: Anne Vachon Dougherty, 3173 Cedar Road, Yorktown Heights, NY, 10598, US

(73) Assignee: International Business Machines Corporation, Armonk, NY (US)

(21) Appl. No.: 10/091,933

(22) Filed: Mar. 6, 2002

Related U.S. Application Data
(60) Provisional application No. 60/334,521, filed on Nov. 30, 2001.

(51) Int. Cl. H04J 3/16; H04N 7/12

(52) U.S. Cl. 370/465; 375/240.18; 348/404.1

(57) ABSTRACT

An apparatus and method for improving the delivery of a digital multimedia stream over a lossy packet network. The method consists in creating data packets of equivalent perceptual relevance to the end-user and as of equal length as possible. Therefore a packet loss induces the same perceptual degradation independently of its location in the multimedia stream.

### CROSS REFERENCE TO RELATED APPLICATIONS

This application claims the benefit under 35 USC 119(c) of U.S. provisional application 60/334,521, which was filed on Nov. 30, 2001. The application also relates to the co-pending patent application entitled “System and Method for Encoding Three-Dimensional Signals Using A Matching Pursuit Algorithm”, Ser. No. ______, which claims the benefit under 35 USC l 19(c) of U.S. provisional application 60/334,521, filed Nov. 30, 2001, as well as the co-pending patent application entitled “Transcoding Proxy and Method for Transcoding Encoded Streams”, Ser. No. ______, which claims the benefit under 35 USC 119(c) of U.S. provisional application 60/334,514, filed Nov. 30, 2001.

### FIELD OF THE INVENTION

This invention relates generally to digital signal representation, and more particularly to an apparatus and method to improve the delivery quality of a digital multimedia stream over a lossy packet network. The invention has particular application with regard to the real-time streaming of compressed audiovisual content over heterogeneous networks.

### BACKGROUND OF THE INVENTION

The purpose of source coding (or compression) is data rate reduction. For example, the data rate of an uncompressed NTSC (National Television Systems Committee) TV-resolution video stream is close to 170 Mbps, which corresponds to less than 30 seconds of recording time on a regular compact disk (CD). The choice of a compression standard depends primarily on the available transmission or storage capacity as well as the features required by the application. The most often cited video standards are H.263, H.261, MPEG-1 and MPEG-2 (Moving Picture Experts Group). The aforementioned video compression standards are based on the techniques of discrete cosine transform (DCT) and motion prediction, even though each standard targets a different application (i.e., different encoding rates and qualities). The applications range from desktop video-conferencing to TV channel broadcasts over satellite, cable, and other broadcast channels. The former typically uses H.261 or H.263 while MPEG-2 is the most appropriate compression standard for the video broadcast applications.

Motion prediction operates to efficiently reduce the temporal redundancy inherent to most video signals. The resulting predictive structure of the signal, however, makes it vulnerable to data loss when delivered over an error-prone network. Indeed, when data loss occurs in a reference picture, the lost video areas will affect the predicted video areas in subsequent frame(s), in an effect known as temporal propagation.

Tri-dimensional (3-D) transforms offer an alternative to motion prediction. In this case, temporal redundancy is reduced the way spatial redundancy is; that is, using a mathematical transform for the third dimension (e.g., wavelets, DCT). Algorithms based on 3-D transforms have proven to be as efficient as coding standards such as MPEG-2, and comparable in coding efficiency to H.263. In addition, error resilience is improved since compressed 3-D blocks are self-decodable.

Non-orthogonal transforms present several properties that provide an interesting alternative to orthogonal transforms like DCT or wavelet. Decomposing a signal over a redundant dictionary improves the compression efficiency, especially at low bit rates where most of the signal energy is captured by few elements. Moreover, video signals issued from decomposition over a redundant dictionary are more resistant to data loss. The main limitation of non-orthogonal transforms is encoding complexity.

Matching pursuit algorithms provide a way to iteratively decompose a signal into its most important features with limited complexity. The matching pursuit algorithm will output a stream composed of both atom parameters and their respective coefficients. The problem with the state-of-the-art in matching pursuit is that the dictionaries do not address the need for decomposition along both the spatial and temporal domains, and also the optimization of source coding quality versus decoding complexity for a given bit rate.

The art in Matching Pursuit (MP) coding is limited. A publication by S. G. Mallat and Z. Zhang, entitled “Matching Pursuits With Time-Frequency Dictionaries”, Transactions on Signal Processing, Vol. 41, No. 12, December 1993 details one application of matching pursuit coding. In addition, the publication entitled “Very Low Bit-Rate Video Coding Based on Matching Pursuits”, by R. Neff and A. Zakhor, Circuits and Systems for Video Technology, Vol. 7, No. 1, February 1997, the publication entitled “Decoder Complexity and Performance Comparison of Matching Pursuit and DCT-Based MPEG-4 Video Codecs”, by R. Neff, T. Nomura and A. Zakhor, Circuits and Systems for Video Technology, Vol. 7, No. 1, February 1997, and U.S. Pat. No. 5,699,121, detail using a 2-D matching pursuit coder to compress the residual prediction error resulting from motion prediction.

The shortcomings of the prior art include, first, that matching pursuit has never been proposed for coding 3-D signals. Second, the basic functions have been limited to Gabor functions because they were proven to minimize the uncertainty principle. However these functions are generally isotropic (same scale along x- and y-axes) and do not address image characteristics such as contours and textures. The above-referenced co-pending patent application discloses a 3-D encoding system and method.

Transmitting multimedia in digital form is the direct result of the benefits offered by digital compression. The purpose of compression is data rate reduction, which results in lower transmission costs. However, distortion which the end-user perceives results from compression artifacts, packet losses, delays, and delay jitters. All lossy multimedia compression schemes distort and delay the signal. Degradation mainly comes from the quantization, which is the only irreversible process in a coding scheme. Moreover, delays and packet losses are inevitable during transfers across today's networks. The delay is generally caused by propagation and queuing. Multiplexing overloads of high magnitude and duration, leading to buffer overflow in the nodes, mainly causes information loss. Data loss is particularly annoying in video streaming applications due to the predictive structure of the compression techniques such that loss of packets creates perceptible video interruption for an end-user/viewer. Interactive multimedia delivery can significantly be improved by providing sender-side, in-network mechanisms. These include (i) structuring techniques and scalable coding to reduce data loss sensitivity, and (ii) forward error correction (FEC) mechanisms to lower the probability of loss at the application layer. On the sending end, redundancy is added to the data so that the receiver can recover from losses or errors without any further intervention from the sender. FEC techniques also often take advantage of the underlying multimedia content leading to an equal error protection scheme. The former results in a higher protection while being computationally heavy. The latter, while being less efficient, can easily be implemented within the network, in so-called gateways.

Most of the multimedia delivery schemes produce packets with highly different value. For example, a loss of a packet containing a portion of an MPEG I frame has much higher visual impact than the loss of a packet containing a portion of an MPEG B frame (temporal propagation). However, any packet has the same probability of being lost on best effort networks.

What is needed, therefore, and what is an objective of the invention, is a system and method for creating data packets of equivalent perceptual value to the end-user and of as equal length as possible, whereby packet loss induces the same perceptual degradation independently of its location in the multimedia stream.

Yet another objective of the invention is to provide a system and method which facilitates easy error protection and stream thinning in multimedia gateways.

### SUMMARY OF THE INVENTION

The foregoing and other objectives are realized by the present invention which provides an apparatus and method for improving the delivery of a digital stream over an error-prone packet network. The method comprises creating data packets of equivalent perceptual relevance to the end-user and as of equal length as possible, such that packet loss induces the same perceptual degradation independently of its location in the multimedia stream. The method also permits for easy error protection in multimedia gateways. The preferred embodiment describes the method applied to a multimedia compression scheme built around a matching pursuit algorithm, although the method is applicable to any data streams, including 1-D, 2-1) and 3-D encoded streams.

### BRIEF DESCRIPTION OF THE DRAWINGS

The advantages of the present invention will become readily apparent to those ordinarily skilled in the art after reviewing the following detailed description and accompanying drawings, wherein:

FIG. 1 is a block diagram illustrating the overall architecture in which the present invention takes place;

FIG. 2 illustrates the Signal Transform Block 100 from FIG. 1;

FIG. 3 is a flow graph illustrating the Matching Pursuit iterative algorithm of FIG. 2,

FIG. 4 shows an example of a spatio-temporal dictionary function in accordance with the present invention;

FIG. 5 shows an example of video signal reconstruction after 100 Matching Pursuit iterations;

FIG. 6 shows an example of video signal reconstruction after 500 Matching Pursuit iterations;

FIG. 7 is a block diagram illustrating the inventive packetization;

FIG. 8 illustrates a transmission packet which encapsulates Matching Pursuit iterations, wherein each iteration 801 is composed of an atom index and its respective coefficient, both computed by a Matching Pursuit encoder; and

FIG. 9 is a flow chart depicting the inventive packetization process.

### DETAILED DESCRIPTION OF THE INVENTION

The present invention is directed to packetization of streams to ensure packets of equal perceptual relevance. As noted above, the inventive system and method apply to 1-D, 2-D and 3-D encoded streams. The preferred embodiment is directed to the delivery of 3-D encoded streams, and more particularly to signals encoded using a 3-D Matching Pursuit Algorithm, as covered by the above-referenced co-pending application. The 3-D encoding of the co-pending application will be detailed below for the sake of completeness.

The co-pending invention applies a Matching Pursuit algorithm to encoded 3-D signals and defines a separable 3-D structured dictionary. The resulting representation of the input signal is highly resistant to data loss (non-orthogonal transforms). Also, it improves the source coding quality versus decoding requirements for a given target bit rate (anisotropy of the dictionary).

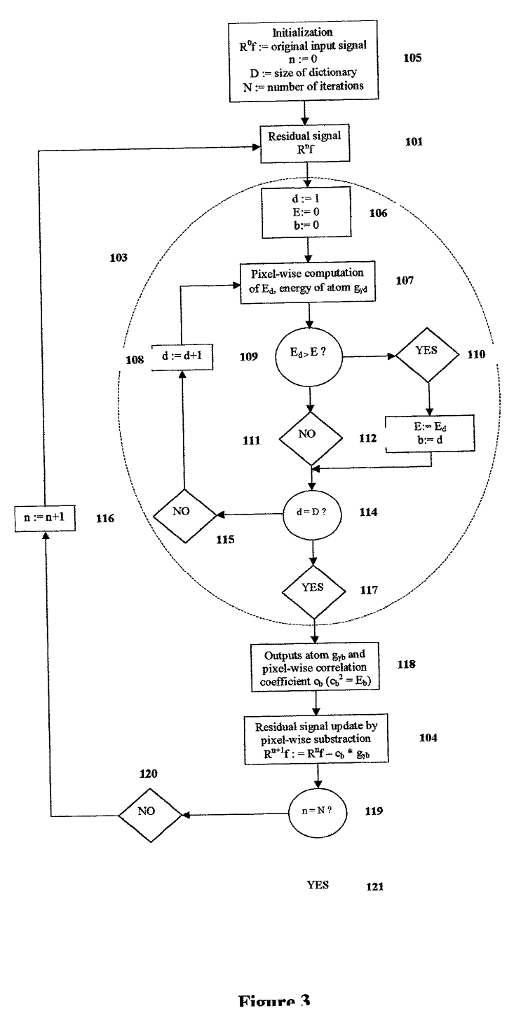

Matching Pursuit (MP) is an adaptive algorithm that iteratively decomposes a function ƒ∈L²( [symbol] ) (e.g., image, video) over a possibly redundant dictionary of functions called atoms (see FIG. 3). Let D={g_{γ}}_{γ∈Γ}be such a dictionary with ∥g_{γ}∥=1. ƒ is first decomposed into:

ƒ= [symbol] g_{γ0} |ƒ [symbol] g_{γ0}+Rƒ,

where [symbol] g_{γ0}|ƒ [symbol] g_{γ0} represents the projection of ƒ onto g_{γ0} and Rƒ is the residual component. Since all elements in D have a unit norm, g_{γ0} is orthogonal to Rƒ, and this leads to:

∥ƒ∥²=| [symbol] g_{γ0}|ƒ [symbol] |²+∥Rƒ∥².

In order to minimize ∥Rƒ∥ and thus optimize compression, one must choose g_{γ0} such that the projection coefficient | [symbol] g_{γ0}|ƒ [symbol] | is at a maximum. The pursuit is carried further by applying the same strategy to the residual component. After N iterations, one has the following decomposition for ƒ:

$$f = {\sum }_{n = 0}^{N - 1} ⟨ {g}_{yn} \vert {R}^{n} f ⟩ {g}_{yn} + {R}^{N} f ,$$

with, R⁰ƒ=ƒ. Similarly, the energy ∥ƒ∥² is decomposed into:

$${‖ f ‖}^{2} = {\sum }_{n = 0}^{N - 1} \vert ⟨ {g}_{yn} \vert {R}^{n} f ⟩ {\vert}^{2} + \vert \vert {R}^{N} f {\vert \vert}^{2} .$$

Although matching pursuit places very few restrictions on the dictionary set, the structure of the latter is strongly related to convergence speed and thus to coding efficiency. The decay of the residual energy ∥Rⁿƒ∥² has indeed been shown to be upper-bounded by an exponential, whose parameters depend on the dictionary. However, true optimization of the dictionary can be very difficult. Any collection of arbitrarily sized and shaped functions can be used, as long as completeness is respected.

The 3-D encoding method is useful in a variety of applications where it is desired to produce a low to medium bit rate video stream to be delivered over an error-prone network and decoded by a set of heterogeneous devices. Let first the dictionary define the set of basic functions used for the signal representation. The basic functions are called atoms. The atoms are represented by a possibly multi-dimensional index γ, and the index along with a correlation coefficient c_{γi} forms an MP iteration.

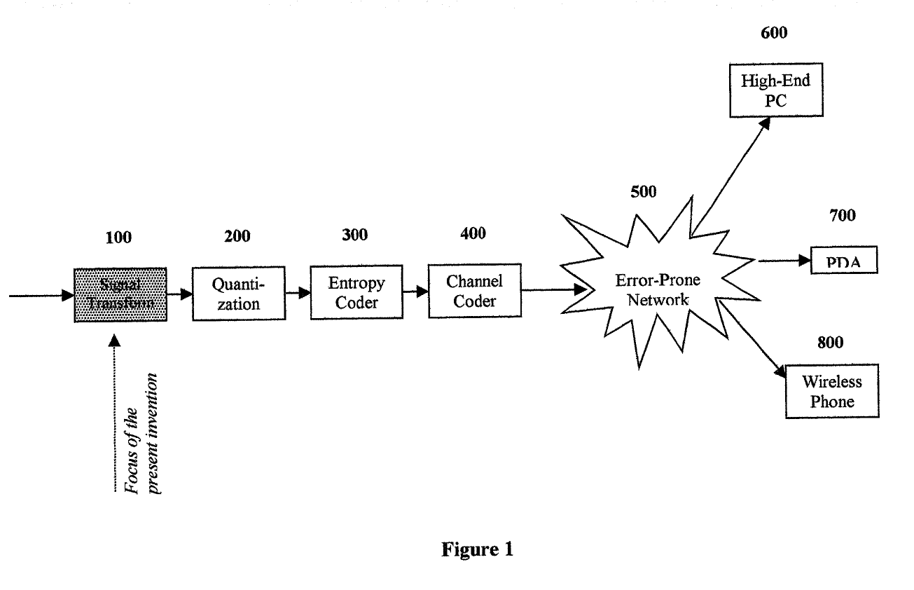

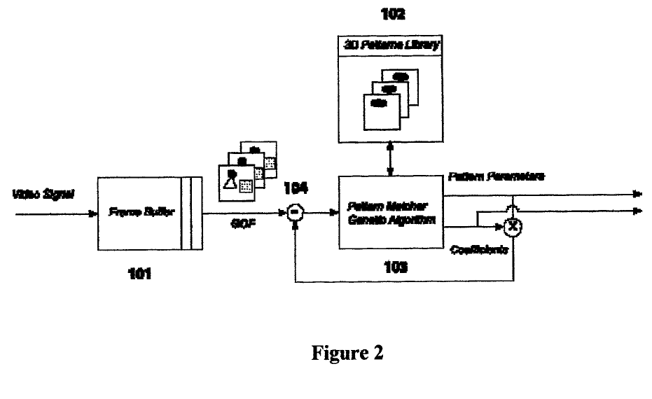

As illustrated in FIG. 2, the original video signal ƒ is first passed to a Frame Buffer 101 to form groups of K video frames of dimension X×Y. The method thus decomposes the input video sequence into K-frames long independent 3D blocks. The dictionary 102 is composed of atoms, which are also 3-D functions of the same size, i.e., K×X×Y. The method as shown in FIG. 3 iteratively compares the residual 3-D function with the dictionary atoms and elects in the Pattern Matcher 103 the 3-D atom that best matches the residual signal (i.e., the atom which best correlates with the residual signal). The parameters of the elected atom, which are the index γ and the coefficient c_{γi} are sent across to the following block performing the Coding (i.e., quantization, entropy coding probably followed by channel coding, as shown in FIG. 1). The pursuit continues up to a predefined number of iterations N, which is either imposed by the user, or deduced from a rate constraint and/or a source coding quality constraint.

The method relies on a structured 3-D dictionary 102, which allows for a good trade-off between dictionary size and compression efficiency. In our method, the dictionary is constructed from separable temporal and spatial functions, since features to capture are different in spatial and temporal domains. An atom dictionary is therefore written as g_{γ}(x, y, k)=Ψ⁻¹×S_{γs}(x,y)×T_{γt}(k), where γ corresponds to the parameters that transform the generating function. The parameter Ψ is chosen so that each atom is normalized, i.e., ∥g_{γ}(x, y, k)∥²=1. Each entry of the dictionary therefore consists in a series of 7 parameters. The first 5 parameters specify position, dilation and rotation of the spatial function of the atom, S_{γs}(x,y). The last 2 parameters specify the position and dilation of the temporal part of the atom, T_{γt}(k).

The spatial function in the method is generated using B-splines, which present the advantages of having a limited and calculable support, and optimizes the trade-off between compression efficiency (i.e., source coding quality for a given target bit rate) and decoding requirements (i.e., CPU and memory requirements to decode the input bit stream). A B-spline of order n is given by:

$${β}^{n} ( x ) = \frac{1}{n !} {\sum }_{k = 0}^{n + 1} ( \begin{matrix}n + 1 \\ k\end{matrix} ) {{( - 1 )}^{k} [ x - k + \frac{n + 1}{2} ]}_{+}^{n} ,$$

where [γ]₊ⁿ represents the positive part of yⁿ.

The 2-D B-spline is formed with a 3rd order B-spline in one direction, and its first derivative in the orthogonal direction to catch edges and contours. Rotation, translation and anisotropic dilation of the B-spline generates an overcomplete dictionary. The anisotropic refinement permits to use different dilation along the orthogonal axes, in opposition to Gabor atoms. Our spatial dictionary maximizes the trade-off between coding quality and decoding complexity for a specified source rate. The spatial function of the 3-D atoms can be written as S_{γs}=S_{γx}^{x}×S_{γy}^{y}, with:

$${S}_{yx}^{x} ( x ) = {β}^{3} ( \frac{cos ( ϕ ) ( x - {p}_{x} ) + sin ( ϕ ) ( y - {p}_{y} )}{{d}_{x}} ) , \\ \begin{matrix}{S}_{yy}^{y} ( y ) = {β}^{2} ( \frac{sin ( ϕ ) ( x - {p}_{x} ) - cos ( ϕ ) ( y - {p}_{y} )}{{d}_{y}} + \frac{1}{2} ) - \\ {β}^{2} ( \frac{sin ( ϕ ) ( x - {p}_{x} ) - cos ( ϕ ) ( y - {p}_{y} )}{{d}_{y}} - \frac{1}{2} ) .\end{matrix}$$

The index γₛ is thus given by 5 parameters; these are two parameters to describe an atom's spatial position (pₓ, p_{y}), two parameters to describe the spatial dilation of the atom (dₓ,d_{y}) and the rotation parameter φ.

The temporal function is designed to efficiently capture the redundancy between adjacent video frames. Therefore T_{γt}(k) is a simple rectangular function written as:

$${T}_{yt} ( k ) = \{ \begin{matrix}1 & if {p}_{k} \leq k < {p}_{k} + {d}_{k} \\ 0 & otherwise\end{matrix} \} .$$

The temporal index γₜ is here given by 2 parameters; these are one parameter to describe the atom's temporal position pₖ and one parameter to describe the temporal dilation dₖ.

The index parameters range (pₓ, p_{y}, pₖ, dₓ, d_{y}, dₖ, φ) is designed to cover the size of the input signal. Spatial-temporal positions allow to completely browse the 3D input signal, and the dilations values follow an exponential distribution up to the 3D input signal size. The basis functions may however be trained on typical input signal sets to determine a minimal dictionary, trading off the compression efficiency.

FIG. 1 is a block diagram illustrating the overall architecture in which the 3-D encoding takes place. The Signal Transform block 100 is the focus of the co-pending application at which the foregoing transformation takes place. After transformation, the digital signal is quantized 200, entropy coded 300 and packetized 400 for delivery over the error-prone network 500. A wide range of decoding devices are targeted; from a high-end PC 600, to PDAs 700 and wireless devices 800.

FIG. 2 illustrates the Signal Transform Block 100. The video sequence is fed into a frame buffer 101, and where a spatio-temporal signal is formed. This signal is iteratively compared to functions of a Pattern Library 102 through a Pattern Matcher 103. The parameters of the chosen atoms are then sent to the quantization block 200, and the corresponding features are subtracted from the input spatio-temporal signal.

FIG. 3 is a flow chart illustrating the Matching Pursuit iterative algorithm of FIG. 2. The Residual signal 101, which consists in the input video signal at the beginning of the Pursuit, is compared to a library of functions and the best matching atom is elected by a Pattern matcher 103. The contribution of the chosen atom is removed from the residual signal 104 to form the residual signal of the next iteration.

The Pattern Matcher 303 basically comprises an iterative loop within the MP algorithm main loop, as shown in FIG. 3. The residual signal is compared with the functions of the dictionary by computing, pixel-wise, the correlation coefficient between the residual signal and the atom. The square of the correlation coefficient represents the energy of the atom (107). The atom with the highest energy (112) is considered as the atom that best matches the residual signal characteristics and is elected by the Pattern Matcher. The atom index and parameters and sent across (118) the Entropy Coder as shown in FIG. 2, and the residual signal is updated in consequence (104). To increase the speed of the encoding, the best atom search can be performed only on a well-chosen subset of the dictionary functions. However, such a method may result in a sub-optimal signal representation.

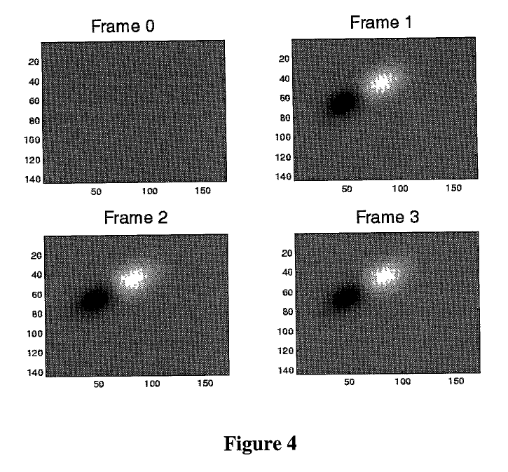

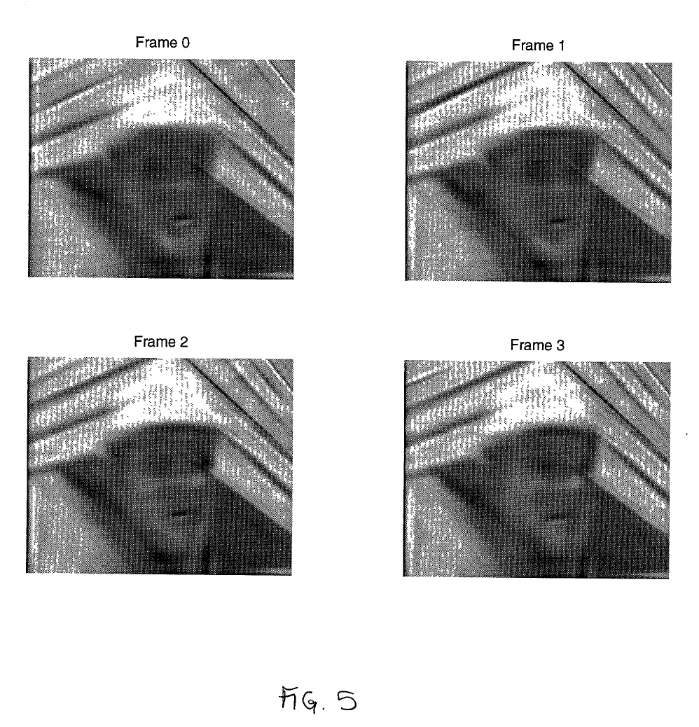

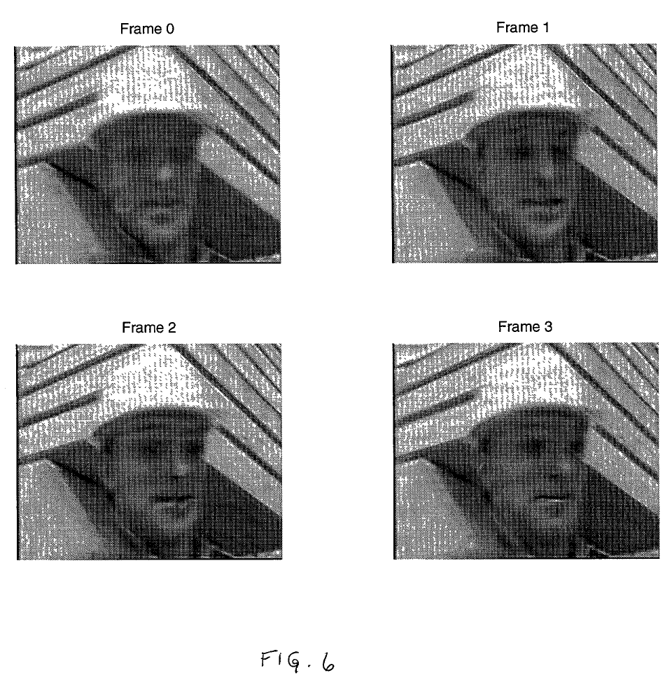

FIG. 4 shows an example of a spatio-temporal dictionary function for use with the present invention. FIG. 5 shows an example of video signal reconstruction after 100 Matching Pursuit iterations. FIG. 6 shows an example of video signal reconstruction after 500 Matching Pursuit iterations. Clearly the amount of signal information improves with successive iterations.

Given the output of the Matching Pursuit algorithm, the inventive packetization method next provides a way to distribute the atoms of an audio, image or video segment into a given number of packets. As noted above, the packetization method can be applied to 1-dimensional, 2-dimensional, or 3-dimensional compressed signals. The number of iterations is imposed by the compression algorithm and directly impacts the coding rate and quality. It has been shown in the literature that the energy iteratively captured by each atom is exponentially decreasing. This property is at the heart of the proposed method.

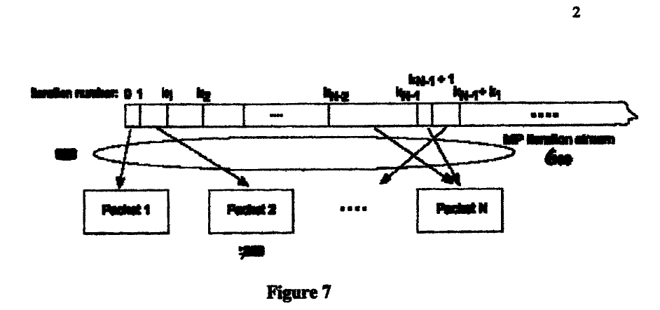

FIG. 7 is a block diagram illustrating the inventive packetization. The Matching Pursuit iteration stream 700, where an iteration means an atom index, along with the respective correlation coefficients, is packetized into N equivalent energy packets 200. The number of packets N is given by the negotiated transmission rate and packet size. The number of iterations fed into each packet (i.e., the Ki values) is given by a recurrence formula presented below. Iterations are considered as basic entities and an entire number of iterations is fed into each packet. The packetization process terminates when all iterations have been encapsulated.

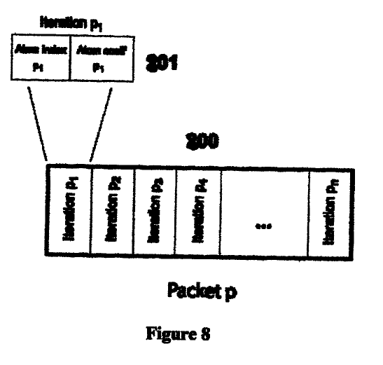

FIG. 8 illustrates a transmission packet which encapsulates Matching Pursuit iterations. An iteration 801 is composed of an atom index and its respective coefficient both computed by a Matching Pursuit encoder. The packetization method is applicable to any encoded stream obtained by transforming the original signal with either a non-linear transform (e.g., matching pursuit) or a linear transform (e.g., Discrete Cosine Transform or wavelets) followed by a non-linear operation to insure the decreasing-energy ordering of the transform coefficients. The transform coefficients include, in the special case of matching pursuit transform, the illustrated correlation coefficients and the parameters of the set of atoms constituting the encoded stream. The packetization method takes advantage of the fact that the energy of an atom decreases exponentially with the iteration number. Therefore, by staggering the packets into which successive atoms are placed, the relative energy of each packet can be equalized.

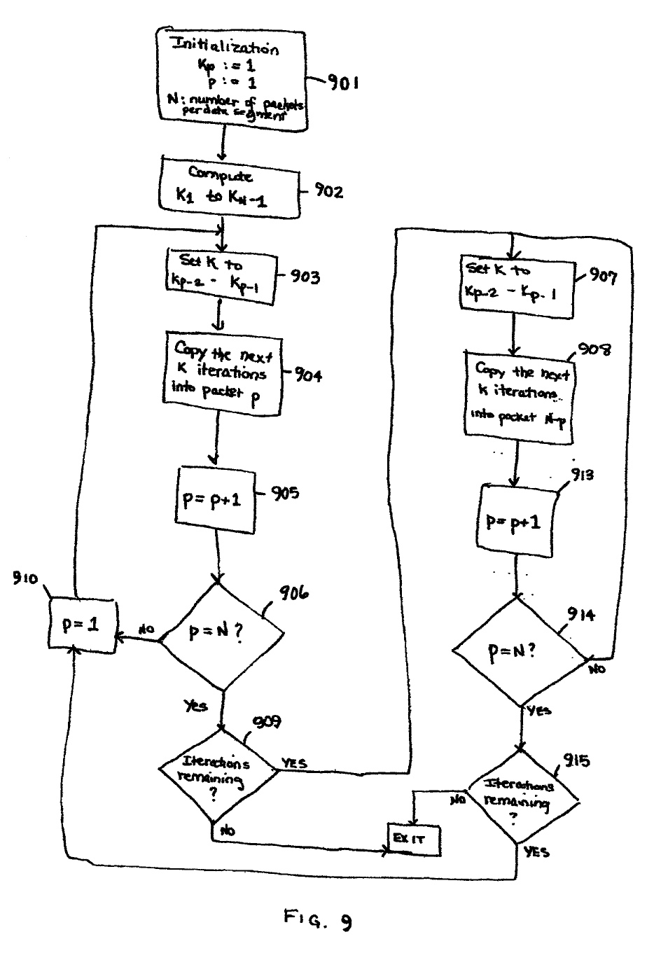

The packetization method works as follows (see FIG. 9) assuming the number of packets N per audio, image or video segment is given. The number of packets N is generally computed once the length of the data segment (i.e., the number of iterations used to code the signal ƒ) and the average packet size (given by the transmission settings) are known. The packetization basically copies the MP stream iterations into packets in two very similar loops. Along each loop, an increasing number of iterations is copied into each transmission packet, so that every packet contains the same energy. In the first loop, the packets are taken in a forward order. The scanning order is reversed in the second loop to balance the packet size.

At initialization 901, the packet number p is set to 1 and the index k is set to 1 (k₀=1). An iteration represents the smallest independent entity in the packetization process and comprises an atom and its respective coefficient (see FIG. 8). Next the values of kᵢ are computed 902 according to the following recursive relation, where υ is the decay parameter of the exponential mentioned here above:

$${k}_{i + 1} = \frac{log ( {υ}^{{k}_{i}} + υ - 1 )}{log ( υ )} , with {k}_{0} = 1.$$

The parameter υ only depends on the dictionary used in the Matching Pursuit and is given as an input parameter to the packetization algorithm. The number of packets N is given by the negotiated transmission rate and packet size. The kᵢ values are computed in such a way that the same energy is put into every packet, assuming an exponential energy decay along the MP stream. The number of iterations 903 copied into each packet at 904 is directly given by the kᵢ parameters. The packet number p is then incremented at 905, and the process is repeated as long as the packet number is smaller than N as determined at 906. When the packetization process reaches the N^{th} packet, it begins another loop 911, resetting p to 1 (912) but using the same kᵢ values 907 as in the previous loop. The second loop however inverses the packet order in 908, whereby the next k iterations are copies into packet N-p. The packetization proceeds in two loops taking feeding packets in an alternating manner to balance the packet sizes. The packet number is then incremented at 913 and the process repeats the same loop while the packet number is smaller than N as determined at 914. When the packet number is equal to N, the process switches to the first loop, resetting p to 1 (910). The packetization process terminates when all iterations have been encapsulated, as determined at steps 909 and 915.

Upon completion, the disclosed process will have encapsulated all iterations into data packets having the same energy and the same resulting visual significance. Consequently, as the packets are being streamed, the loss of any single packet will have minimal perceptible impact on the display being consumed by the end user.

The invention has been detailed in terms of preferred embodiments such as Matching Pursuit compression of 3D signals. One having skill in the art will recognize that modifications may be made without departing from the spirit and scope of the invention as set forth in the appended claims, such that DCT compression and other operations yielding decreasing-energy ordering of transform coefficients for 1D, 2D or 3D signals can make use of the inventive packetization method.

What is claimed is:

1. A method for distributing transform coefficients of encoded information streams into N packets, said method comprising:
a. inserting the k₁ transform coefficients into the first packet, then inserting the next k₂ transform coefficients into the second packet until k_{N} transform coefficients are inserted into the N^{th} packet; and
b. repeating the process in the above step in a reverse order, starting with the N^{th} packet where the k_{N+1} transform coefficients are placed in the N^{th} packet, then the next k_{N+2} transform coefficients are inserted into packet N−1 until the k_{2N-1} transform coefficients are placed in the first packet; and
c. repeating the above two steps until all transform coefficients are placed in the N packets.

2. The method of claim 1 further comprising encoding said stream by transforming the original signal with a non-linear transform.

3. The method of claim 2 wherein said non-linear transform comprises applying a matching pursuit algorithm.

4. The method of claim 3 wherein applying said matching pursuit algorithm comprises the steps of:
a. generating K frames of dimension X by Y from said stream;
b. comparing a residual signal with a dictionary of functions, said residual signal being the information stream, and said dictionary containing temporal and spatial functions;
c. selecting a function which best matches the residual signal;
d. encoding said information stream using parameters and correlation coefficients of said selected function;
e. generating a new information stream from said encoded stream; and
f repeating the steps b, c, d and e on said new information stream until a predefined constraint on either the quality of the encoded stream or the bit rate of the encoded stream is met; and
g. repeating the above steps until the end of the information stream is reached.

5. The method of claim 4 where said applying further comprises creating a dictionary comprising temporal and spatial functions prior to said generating said frames.

6. The method of claim 1 further comprising encoding said stream by transforming the original signal with a linear transform.

7. The method of claim 6 wherein said linear transform comprises applying a Discrete Cosine Transform.

8. The method of claim 6 wherein said linear transform comprises applying a wavelet transform.

9. A program storage device readable by machine tangibly embodying a program of instructions for said machine to perform a method for distributing transform coefficients of encoded information streams into N packets, said method comprising:
a. inserting the k₁ transform coefficients into the first packet, then inserting the next k₂ transform coefficients into the second packet until k_{N} transform coefficients are inserted into the N^{th} packet;
b. repeating the process in the above step in a reverse order, starting with the N^{th} packet where the k_{N+1} transform coefficients are placed in the N^{th} packet, then the next k_{N+2} transform coefficients are inserted into packet N−1 until the k_{2N-1} transform coefficients are placed in the first packet; and
c. repeating the above two steps until all transform coefficients are placed in the N packets.

10. An improved processing system for distributing transform coefficients of encoded information streams into N packets for delivery, said improvement comprising:
processing means adapted to provide improved processing by inserting k₁ transform coefficients into a first packet, then inserting the next k₂ transform coefficients into a second packet until k_{N} transform coefficients are inserted into the N^{th} packet; repeating the process in a reverse order, starting with the N^{th} packet where the k_{N+1} transform coefficients are placed in the N^{th} packet, then the next k_{N+2} transform coefficients are inserted into packet N−1 until the k_{2N-1} transform coefficients are placed in the first packet; and repeating the above two steps until all transform coefficients are placed in the N packets.

11. The improved processing system of claim 10 wherein said improved processing further comprises encoding said stream by transforming the original signal with a non-linear transform.

12. The improved processing system of claim 11 wherein said non-linear transform comprises applying a matching pursuit algorithm.

13. The improved processing system of claim 12 wherein said system additionally comprises apparatus for representing a video information stream prior to coding and transmission, said apparatus comprising:
a. frame buffer component for generating K frames of dimension X by Y from said stream;
b. pattern matcher component for comparing a residual signal with a dictionary of functions, said residual signal being the information stream, and said dictionary containing temporal and spatial functions and for selecting a function which best matches the residual signal;
c. quantization component for encoding said information stream using parameters and correlation coefficients of said selected function and for generating a new information stream from said encoded stream; and
d. threshold component for terminating said steps of comparing, selecting, encoding, and generating when a predefined constraint on the quality of the encoded stream or the bit rate of the encoded stream is met and when the end of the information stream is reached.

14. The improved processing system of claim 13 wherein said apparatus further comprises a dictionary comprising temporal and spatial functions for use by said pattern matcher.
